(19) United States
(12) Patent Application Publication
(10) Pub. No.: US 2006/0011760 A1
(43) Pub. Date: Jan. 19, 2006

(54) Mixer blade

(76) Inventor: Maxwell Hsu, Tao-Yuan (TW)

Correspondence Address: Yi-Wen Tseng, 4331Stevens Battle Lane, Fairfax, VA, 22033, US

(21) Appl. No.: 10/879,103

(22) Filed: Jun. 30, 2004

(51) Int. Cl. B02C 18/12

(52) U.S. Cl. 241/92

(57) ABSTRACT

A mixer blade is provided. The mixer blade includes a main body and a cutting blade. The main body is in circular shape. A coupling portion is formed at the central portion of the main body, while many zigzag first cutting portions are formed around the coupling portion. On the other hand, the cutting blade includes a connecting portion and a second cutting portion. The connecting portion is affixed to the main body via the coupling portion. The second cutting portion includes a first blade portion and a second blade portion. The blade portions are disposed in opposite directions. Consequently, vegetables or fruits of larger size can be ground finer, so as to enhance the juicing rate and the convenience of usage of the mixer.

### BACKGROUND OF THE INVENTION

The present invention relates generally to a mixer, and more particularly to the blade structure of the mixer that is disposed on the rotation axis of the mixer. The blade structure can grind larger size vegetables so as to enhance the applicability of mixers.

Modern people are more and more conscious about dietary health. Since vegetables and fruits are rich in various kinds of vitamins, they are beneficial to the immune system of a human body. On the other hand, each vegetable or fruit comprises different nutritious facts. One can employ a mixer to grind different kinds of vegetables and fruits and to get a cup of highly nutritious and delicious juice. However, the primary factor affecting the juicing rate of a mixer is the design of blade structure. Therefore, the present invention provides a new mixer blade design that can optimize the juicing rate.

A conventional mixer blade is disclosed in Taiwanese new utility patent no. 493417. The mixer blade includes a plurality of curved cutting blades arranged in a cross shape, wherein one cutting blade crosses the center of the juicing plate, so as to grind the center portion of the inserted vegetables or fruits as the juicing plate rotates.

However, there are still some drawbacks presented in the conventional mixer blade discussed above. Since the curved cutting blade and the vegetables or fruits form a linear contact, there is thus a larger grinding resistance, which requires a motor of larger power or a transmission shaft of larger radius. This keeps the cost of the mixer in an inevitably high level. In addition, the curved cutting blade grinds the fruit into slices of fruit meat. Since no further grinding is provided, the juice stored in the fruit meat is not sufficiently separated therefrom, which largely reduces the juicing rate. Further, since the curved cutting blade and the juicing plate are integrated into one entity, the entire mixer blade should be replaced when the cutting blade wears away after some particular amount of time. This increases the maintenance cost of the mixer.

Consequently, the inventor of the present invention devoted himself to developing a new mixer that can resolve the above drawbacks, as will be described in detail hereinafter.

### BRIEF SUMMARY OF THE INVENTION

The present invention is to provide a mixer blade that can grind vegetables or fruits of larger size so as to enhance the juicing rate and the convenience of usage of a mixer.

In order to achieve the above and other objectives, the mixer blade of the present invention includes a main body and a cutting blade. The main body is in a circular shape. A coupling portion is formed at the central portion of the main body, while many zigzag first cutting portions are formed around the coupling portion. On the other hand, the cutting blade includes a connecting portion and a second cutting portion. The connecting portion is affixed to the main body via the coupling portion. The second cutting portion includes a first blade portion and a second blade portion. The blade portions are disposed in opposite directions. Therefore, the objectives set forth above is achieved.

### BRIEF DESCRIPTION OF THE DRAWINGS

FIG. 1 is an explosive view of a mixer blade in accordance with one embodiment of the present invention.

FIG. 2 is a perspective view of the mixer blade in accordance with one embodiment of the present invention.

FIG. 3 is a sectional view of the mixer blade of the present invention in combination with a mixer.

FIG. 4 is an explosive of the mixer blade in accordance with another embodiment of the present invention.

### DETAILED DESCRIPTION OF THE INVENTION

In order to better understanding the features and technical contents of the present invention, the present invention is hereinafter described in detail by incorporating with the accompanied drawings. However, the accompanied drawings are only for the convenience of illustration and description, no limitation is intended thereto.

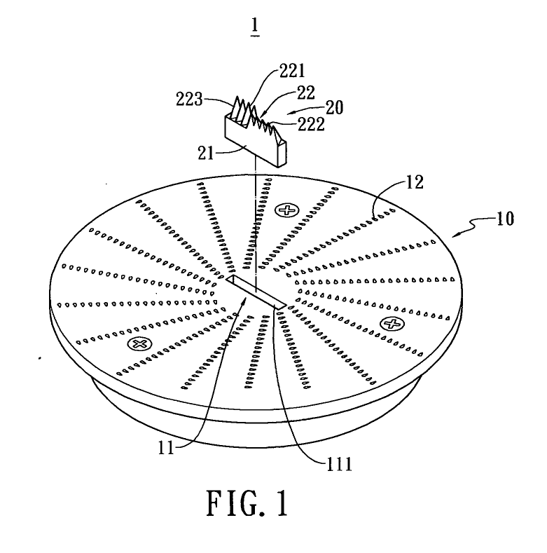

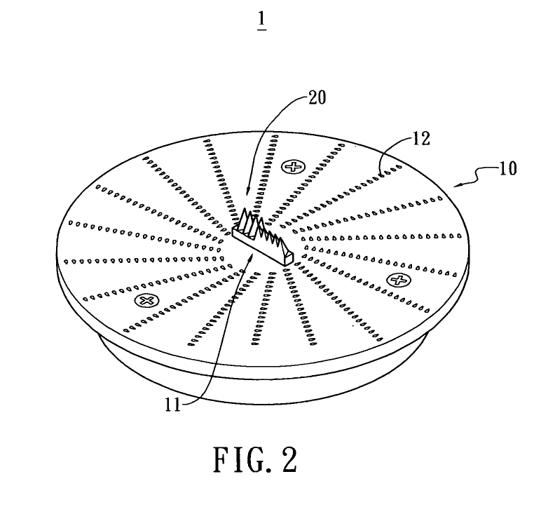

Referring to FIG. 1 and FIG. 2, an explosive review and a perspective view of a mixer blade of the present invention is respectively illustrated. The mixer blade 1 includes a main body 10 and a cutting blade 20.

The main body 10 is in a circular shape, made of stainless steel or ceramic materials. A coupling portion 11 is formed on the central portion of the main body 10. The coupling portion 11 can be in a circular shape, a right polygon shape or other geometrical shapes. In this particular embodiment, the coupling portion 11 is in a circular shape. Around the coupling portion 11, a plurality of first cutting portions 12 is radially arranged. Each of the first cutting portions 12 can be a zigzag or a conical shape. In this particular embodiment it is a zigzag shape.

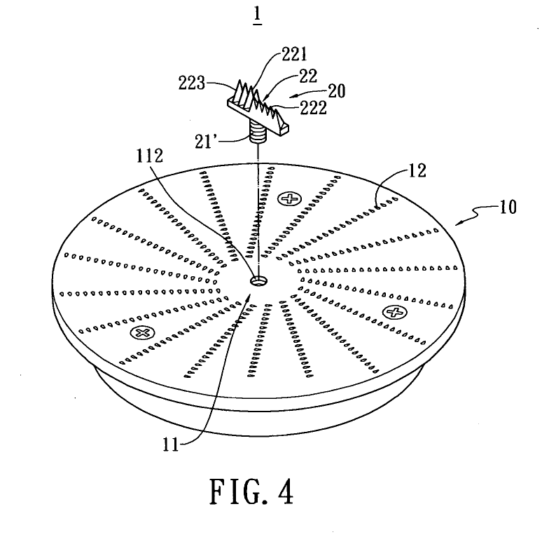

The cutting blade 20 is also made of stainless steel or ceramic materials. The cutting blade 20 includes a connection portion 21 and a second cutting portion 22. The connection portion 21 connects to the central portion of the main body 10 via the coupling portion 11. The coupling between the coupling portion 11 and the connection portion 21 can be either an insertion coupling or a spiral coupling (as shown in FIG. 4). In this particular embodiment, the coupling is the insertion coupling. A rectangular groove 111 is formed at the central portion of the coupling portion 11. The groove 111 is adapted to fit the shape of the connection portion 21, so as to affix the cutting blade 20 on the main body 10. On the other hand, the second cutting portion 22 is disposed on the connection portion 21. The second cutting portion 22 includes a first blade portion 221 and a second blade portion 222. The blade portions 221, 222 are disposed in opposite directions. A plurality of blade edge 223 is formed on the first blade edge 221 and the second blade edge 222. The blade edge 223 is in semi-conical shape. Furthermore, the blade edge 223 of the first blade portion 221 and the blade edge 223 of the second blade portion 222 are mutually interlaced, that is, the position of a blade peak becomes a blade valley after rotating the second cutting portion by 180 degrees.

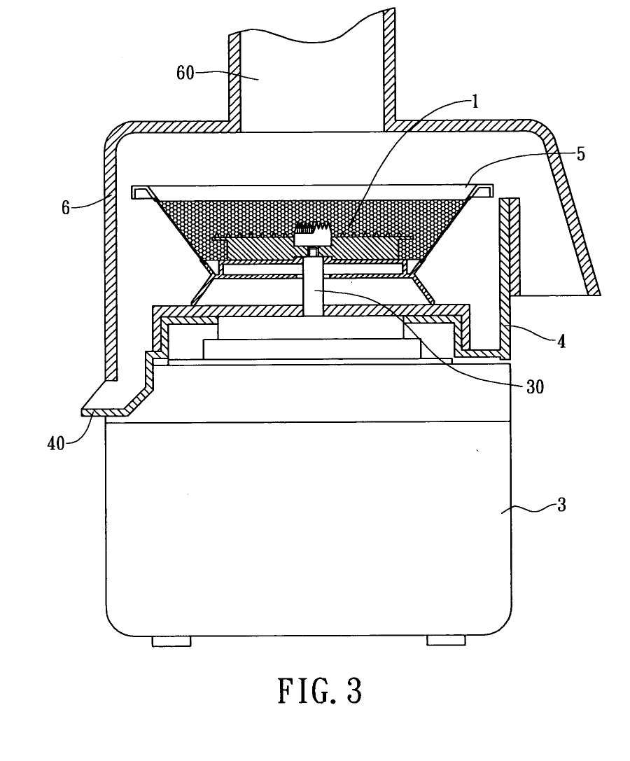

Referring to FIG. 3, a sectional view of the mixer blade of the present invention in combination with a mixer is illustrated. As shown, the mixer blade 1 can be affixed on the mixer. The mixer includes a lower mount 3, an upper mount 4, a filter 5 and a cover 6. A transmission shaft 30 is disposed at the center of the lower mount 3. The transmission shaft 30 is provided to connect the mixer blade 1 of the present invention. The upper mount 4 is harnessed on the lower mount 3. The filter 5 and the mixer blade 1 are disposed in the upper mount 4. There is also a juice output 40 formed at one side of the upper mount. The cover 6 is disposed on the upper mount 4. At the center of the cover 6, a cylindrical material input 60 is formed, so as to throw various vegetables or fruits therethrough. In addition, the center of the material input 60 and the center of the mixer blade 1 are vertically aligned.

By employing the mixer described above, one can throw in vegetables or fruits of a larger size into the material input 60 of the cover 6. Then, using a pushing rod (not shown) to push those vegetables or fruits into the mixer, the mixer blade 1 can thus grind the vegetables or fruits into juice and meat. The juice will flow out through the juice output 40 of the upper mount 4, while the meat will remain on the filter 5.

Accordingly, the mixer blade of the present invention includes at least the following advantages. Since the cutting blade 20 and the main body 10 are coupled to each other, the cutting blade 20 alone can be replaced when worn away, without replacing the entire mixer blade. This can largely reduce the maintenance cost of the mixer. In addition, since the cutting blade 20 is disposed facing the center of the material input 60, that is the material input 60 is moved to the center of the mixer, whereby the radius of the material input 60 can effectively be enlarged without increasing the size of the mixer. Furthermore, since the first blade portion and the second blade portion are interlaced, larger vegetables or fruits can thus be ground finer, thereby enhancing the juicing rate and the convenience of usage.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A mixer blade, comprising:
a main body including a coupling portion formed on the central portion thereof and a first cutting portion disposed around the coupling portion; and
a cutting portion including a connection portion and a second cutting portion, wherein the connection portion is coupled to the central portion of the coupling portion, thereby affixing on said main body, the second cutting portion comprising a first blade edge and a second blade edge formed thereon, wherein the first blade edge and the second blade edge are disposed in opposite directions.

2. The mixer blade as recited in claim 1, wherein said main body is in circular shape.

3. The mixer blade as recited in claim 1, wherein a groove is formed at the coupling portion of said main body for connecting the connecting portion of said cutting portion.

4. The mixer blade as recited in claim 1, wherein the coupling portion of said main body comprises a screw hole and the connecting portion of said cutting blade comprises a screw mount, thereby affixing said cutting blade on said main body.

5. The mixer blade as recited in claim 1, wherein the first cutting portion is radially arranged around the coupling portion.

6. The mixer blade as recited in claim 1, wherein the first cutting portion is in zigzag shape.

7. The mixer blade as recited in claim 1, wherein the first blade portion and the second blade portion of the second cutting blade comprise a plurality of blade edges formed thereon.

8. The mixer blade as recited in claim 7, wherein the blade edges are in semi-conical shape.

9. The mixer blade as recited in claim 7, wherein the blade edges of the first blade portion and the blade edges of the second blade portion are interlaced.
